(19) United States
(12) Patent Application Publication
(10) Pub. No.: US 2010/0241250 A1
(43) Pub. Date: Sep. 23, 2010

(54) Feedback and feedforward control of a semiconductor process without output values from upstream processes

(75) Inventors: Ming Chen, Singapore (SG); Abhijit Kalita, Singapore (SG)

Correspondence Address: SAILE ACKERMAN LLC, 28 DAVIS AVENUE, POUGHKEEPSIE, NY, 12603, US

(73) Assignee: TECH Semiconductor Singapore Ptd Ltd

(21) Appl. No.: 12/381,930

(22) Filed: Mar. 18, 2009

(51) Int. Cl. G05B 13/04; G05B 13/02; G06F 17/00

(52) U.S. Cl. 700/30; 700/45; 700/105; 700/121

(57) ABSTRACT

The present invention discloses a feedback and feedforward process control system, comprising the steps:
1.) Determining an output variable that is highly correlated with the controlled variable, the variation of which is mainly influenced by upstream processes rather than current process,
2.) Processing a semiconductor wafer with a first set of parameters,
3.) Measuring the output variable that is highly correlated with the controlled variable after the semiconductor wafer is processed,
4.) Developing a predictive feedforward signal based on the output variable,
5.) Measuring the controlled variable after the semiconductor wafer is processed to be used as feedback signal, and
6.) Determining a second set of parameters based on feedback and feedforward signals.

### BACKGROUND OF THE INVENTION

(1) Field of the Invention

The present invention relates to a process control method, and more particularly, to a method providing feedback and feedforward control of a semiconductor process without output values from upstream processes.

(2) Description of the Related Art

Semiconductor manufacturing typically involves hundreds of sequential process steps, each one of which could lead to yield loss due to process drift or other variability. Processes change over time as a result of a number of factors such as aging of equipment, deterioration of component parts, life of consumables, fluctuations in ambient conditions, etc. They may also change drastically after preventive or corrective maintenance.

Consequently, control strategies are needed to compensate for disturbances to the system. All compensation control techniques can be classified as feedback or feedforward. Feedback uses measurements of current process outputs to decide the process inputs for the next sample; feedforward uses measurements of upstream process outputs to decide the current process inputs for the current sample. This implies that feedback compensates for process variations while feedforward compensates for incoming wafer variations. To achieve the benefits of both control techniques, combined feedback and feedforward control can be used to improve performance over pure feedback or feedforward control. FIG. 1 shows the block diagram of a conventional feedback and feedforward control system.

In a conventional feedback and feedforward control system, output from the current process provides the feedback signal while output from an upstream process provides the feedforward signal. However, output values from the upstream process may not be available for feedforward control due to several reasons, e.g. lack of metrology tools, difficulty in obtaining reliable measurement, necessity to reduce cycle time, etc. Therefore, a feedforward control system that does not depend on upstream process results is required.

A prior art search was conducted. U.S. Pat. No. RE39,518 to Toprac et al, U.S. Pat. No. 7,101,799 to Paik, U.S. Pat. No. 7,158,851 to Funk, U.S. Pat. No. 7,401,728 to Markham et al, and U.S. Patent Application 2009/0005894 to Bomholt et al may consist of features similar to the present invention. Although these patents relate to a feedback and feedforward control system for semiconductor manufacturing, all of them teach a feedforward control system that uses upstream process results. None of them compensates for incoming wafer variation based on current process results, and not on upstream process results.

### SUMMARY OF THE INVENTION

It is the primary objective of the present invention to provide an effective method of feedback and feedforward control of a semiconductor process.

Another objective of the present invention is to provide a process control system that is able to provide feedforward control even in the absence of upstream process results.

In accordance with the objectives of the invention, there is disclosed a feedback and feedforward process control system. The method comprises the following steps:
1) Determining an output variable that is highly correlated with the controlled variable, the variation of which is mainly influenced by upstream processes rather than current process,
2) Processing a product with a first set of parameters,
3) Measuring the output variable that is highly correlated with the controlled variable after the product is processed,
4) Developing a predictive feedforward signal based on the output variable,
5) Measuring the controlled variable after the product is processed to be used as feedback signal, and
6) Determining a second set of parameters based on feedback and feedforward signals.

### BRIEF DESCRIPTION OF THE DRAWINGS

FIG. 1 is a block diagram showing a conventional feedback and feedforward control system.

FIG. 2 is a block diagram of the feedback and feedforward control system of the present invention.

FIG. 3 is a graphical representation showing correlation between normalized trench depth and critical dimension.

### DETAILED DESCRIPTION OF THE INVENTION

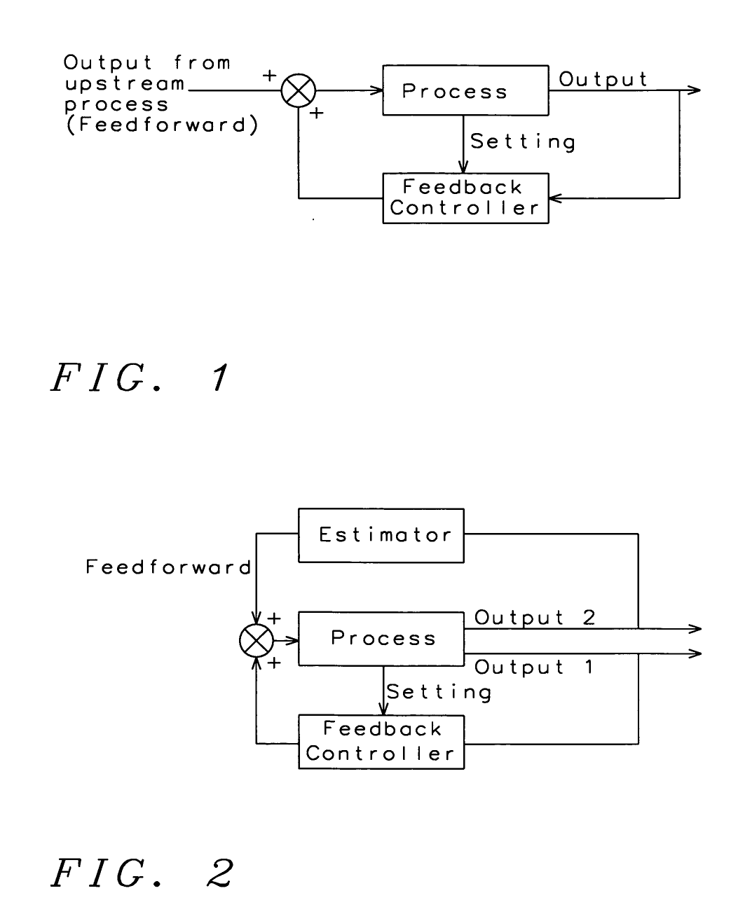

The present invention concerns a semiconductor process that uses measurements of current process outputs to make decisions about the proper values of manipulated inputs of the same process when upstream outputs are unavailable. FIG. 2 shows the proposed feedback and feedforward control system.

In the present invention, two outputs from the current process are measured, either with the same metrology tool or with different metrology tools. One of them (output 1) is the controlled variable and is fed back into the feedback controller, i.e. the input to the feedback controller is the same as what it is trying to control. The other (output 2) is a variable that is highly correlated with the controlled variable, and hence, related to the variability in output 1. In the event that there is no feedforward signal from upstream processes, an estimator is used to predict output 2 for the next sampling period based on historical output 2 data, and the predicted value is fed forward to an earlier part of the control loop. Corrective action to the process recipe setting is then initiated given both feedback and feedforward signals.

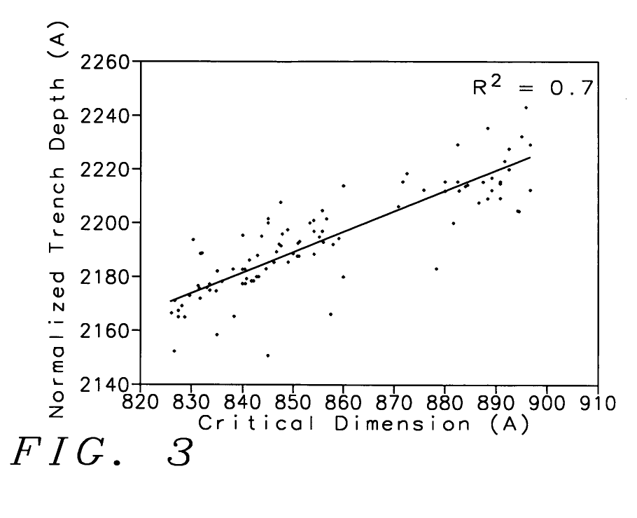

One exemplary embodiment of the invention is used in controlling the trench depth of the shallow trench isolation (STI) etch process. After-develop-inspection (ADI) critical dimension (CD) measured before the STI etch process is not appropriate as a feedforward signal as it is measured in a different structure from trench depth (array for ADI CD vs periphery for trench depth). As there is a strong correlation between normalized trench depth (trench depth normalized with respect to etch time) and its critical dimension (CD), as shown in FIG. 3, trench CD measured at the periphery is used for feedforward compensation. In this example, output 1 and output 2 in FIG. 2 refer to trench depth and trench CD respectively.

A semiconductor wafer or a batch of semiconductor wafers is processed in a plasma etcher under a first set of etching parameters selected to maintain the trench depths within preselected minimum and maximum trench depths. Etching parameters can be etch time, temperature, concentration, etc. After etching, trench depth and trench CD are measured with the same metrology tool. In this case, NOVA Measuring Instruments Ltd's NovaScan Optical CD (OCD) metrology system is used. However, other metrology tools like atomic force microscope (AFM) can also be used. A model-based estimator predicts the CD for the next semiconductor wafer or batch of semiconductor wafers based on a weighted average of the last five CD measurements, for example:

CD_{predicted, t}=c₁×CD_{actual, t-5}+c₂×CD_{actual, t-4}+c₃×CD_{actual, t-3}+c₄×CD_{actual, t-2}+c₅×CD_{actual, t-1} (1)

where subscript “predicted” means predicted value, “actual” means actual measured value and t refers to the current sample. c₁ to c₅ are pre-determined constants.

In some instances, more than one tool may be used in the same upstream process. Mismatch between upstream tools may eventually result in output differences between wafers for the current process. Using the last five CD measurements to predict the CD for the current sample will not be accurate if the last five samples are processed in different tools. Hence, the predicted CD for a sample processed in a particular upstream tool will be determined based on the CD measurements for the last five samples processed in the same upstream tool.

Based on the predicted CD and the measured trench depth, the etching parameters are updated to maintain the trench depths within the minimum and maximum trench depths based on the following equations:

Feedforward: TrenchDepth_{predicted, t}=EtchRate×EtchTimeₜ+Slope×(CD_{predicted, t}−CD_{target})+MPₜ₋₁ (2)

Feedback: MPₜ=MPₜ₋₁+λ×[TrenchDepth_{actual, t}−(EtchRate×EtchTimeₜ+Slope×(CD_{actual, t}−CD_{target})+MPₜ₋₁] (3)

Control law: EtchTimeₜ=[TrenchDepth_{target, t}−Slope×(CD_{predicted, t}−CD_{target})−MPₜ₋₁]/Slope (4)

where Slope is the gradient of trench depth against CD in FIG. 3, MP is the model parameter to estimate chamber drift, λ is the exponentially weighted moving average (EWMA) tuning factor with value between 0 and 1, and subscript “target” refers to the target value.

It will be apparent to those skilled in the art that numerous variations and modifications to the above equations may be made without departing from the spirit of the invention as disclosed.

### ADVANTAGES OF THE INVENTION

Like most other feedback and feedforward control systems, yield and productivity improved due to reduced process variation and disposition of out of control (OOC) or out of specification (OOS) products.

In addition, we note the following advantages specific to the present invention:
Ability to provide feedforward control in the absence of output values from upstream processes.
Reduced cycle time and cost by determining feedback and feedforward signals simultaneously using the same metrology tool.

### ALTERNATIVE EXAMPLES OF THE INVENTION

This invention can be applied to all processes requiring run-to-run control, which may or may not be a semiconductor process.

For example, similar feedback and feedforward control may also be used in lithography to compensate for the effect of incoming wafer profile variation on CD. Wafer profile can be changed by a variety of upstream processes, such as chemical mechanical polishing (CMP), rapid thermal processing (RTP), etc. However, determining wafer profile at these steps requires significant cost and time expenditure. Under such circumstances when it is not cost-effective to measure incoming wafer profile, output values from the current process can be used for feedforward control. In this particular case, feedforward signal to control CD can be the maximum temperature drop during post-exposure bake. Maximum temperature drop during post-exposure bake is defined as the difference between the initial bake plate temperature and the minimum bake plate temperature when the wafer is being processed. The maximum temperature drop is dependent on the incoming wafer profile. Hence, output 1 and output 2 in FIG. 2 refer to CD and maximum temperature drop during post-exposure bake respectively. Based on the predicted maximum temperature drop during post-exposure bake and the measured CD, the process parameters are updated to maintain the CD within specified limits. Process parameters include post-exposure bake temperature, post-exposure bake time, exposure dose and exposure focus.

Although the preferred embodiment of the present invention has been illustrated, and the form has been described in detail, it will be readily understood by those skilled in the art that various modifications, including other types of processes requiring run-to-run control, may be made therein without departing from the spirit of the invention or from the scope of the appended claims.

What is claimed is:

1. A method for a feedback and feedforward process control system comprising:
determining an output variable that is highly correlated with a controlled variable, the variation of which is mainly influenced by upstream processes rather than a current process;
processing a first product through said current process with a first set of parameters;
measuring said output variable that is highly correlated with said controlled variable after said processing;
developing a predictive feedforward signal based on said output variable;
measuring said controlled variable after said processing to be used as a feedback signal, and
determining a second set of parameters based on said feedback and said feedforward signals wherein said second set of parameters is used to process a next product through said current process.

2. The method according to claim 1 wherein said first product and said next product comprise a first and a next semiconductor wafer, or a first and a next batch of semiconductor wafers, respectively.

3. The method according to claim 1 wherein said developing said predictive feedforward signal comprises estimating said output variable based on historical output variables.

4. The method according to claim 1 wherein said current process is a trench etching process, said controlled variable is trench depth and said output variable is trench critical dimension.

5. The method according to claim 4 wherein said first and second sets of parameters comprise etch time, temperature, and concentration.

6. The method according to claim 1 wherein said current process is a lithography process, said controlled variable is critical dimension and said output variable is maximum temperature drop during post-exposure bake.

7. The method according to claim 6 wherein said first and second sets of parameters comprise post-exposure bake temperature, post-exposure bake time, exposure dose and exposure focus.

8. The method according to claim 1 wherein said step of developing a predictive feedforward signal based on said output variable comprises using a model-based estimator to predict said output variable for said next product based on a weighted average of the last set of a predetermined number of output variable measurements.

9. The method according to claim 8 wherein said output variable for a sample processed in a particular upstream tool will be determined based on the output variable measurements for the last said set of samples processed in a same said upstream tool.

10. A method for fabricating an integrated circuit comprising:
providing a first semiconductor substrate;
etching a trench into said first semiconductor substrate in a shallow trench isolation (STI) process wherein said process comprises a first set of parameters;
measuring a depth of said trench to be used as a feedback signal;
measuring a critical dimension of said trench and determining a predictive feedforward signal based on said critical dimension; and
determining a second set of parameters based on said feedback and said feedforward signals wherein said second set of parameters is used in said STI process for a next semiconductor substrate.

11. The method according to claim 10 wherein said first set of parameters are used for a first batch of semiconductor substrates and wherein said second set of parameters are used for a second batch of semiconductor substrates.

12. The method according to claim 10 wherein said determining said predictive feedforward signal comprises estimating said critical dimension based on historical critical dimensions.

13. The method according to claim 10 wherein said first and second sets of parameters comprise etch time, temperature, and concentration.

14. The method according to claim 10 wherein said step of determining a predictive feedforward signal based on said critical dimension comprises using a model-based estimator to predict said critical dimension for said next semiconductor substrate based on a weighted average of the last set of a predetermined number of critical dimension measurements.

15. The method according to claim 14 wherein said critical dimension for a sample processed in a particular upstream tool will be determined based on the critical dimension measurements for the last said set of samples processed in a same said upstream tool.

16. A method for fabricating an integrated circuit comprising:
providing a first semiconductor substrate;
performing a lithography process on said first semiconductor substrate wherein said process comprises a first set of parameters;
measuring a critical dimension to be used as a feedback signal;
measuring a maximum temperature drop during a post-exposure bake step of said lithography process and determining a predictive feedforward signal based on said maximum temperature drop; and
determining a second set of parameters based on said feedback and said feedforward signals wherein said second set of parameters is used in said lithography process for a next semiconductor substrate.

17. The method according to claim 16 wherein said first set of parameters are used for a first batch of semiconductor substrates and wherein said second set of parameters are used for a second batch of semiconductor substrates.

18. The method according to claim 16 wherein said determining said predictive feedforward signal comprises estimating said maximum temperature drop based on historical maximum temperature drop.

19. The method according to claim 16 wherein said first and second sets of parameters comprise post-exposure bake temperature, post-exposure bake time, exposure dose and exposure focus.

20. The method according to claim 16 wherein said step of determining a predictive feedforward signal based on said maximum temperature drop comprises using a model-based estimator to predict said maximum temperature drop for said next semiconductor substrate based on a weighted average of the last set of a predetermined number of maximum temperature drop measurements.

21. The method according to claim 19 wherein said maximum temperature drop for a sample processed in a particular upstream tool will be determined based on the maximum temperature drop measurements for the last said set of samples processed in a same said upstream tool.
